(19) United States
(12) Patent Application Publication
(10) Pub. No.: US 2007/0139323 A1
(43) Pub. Date: Jun. 21, 2007

(54) Display system having liquid crystal display device and external image compensative source

(75) Inventors: Eddy Giing-Lii Chen, Miao-Li (TW); Sz-Hsiao Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/638,807

(22) Filed: Dec. 14, 2006

(30) Foreign Application Priority Data
Dec. 16, 2005 (TW) 94144815

(51) Int. Cl. G09G 3/36

(52) U.S. Cl. 345/87

(57) ABSTRACT

An exemplary display system (400) includes an image compensating source disposed in a video source (420), the image compensating source is configured to generate a compensative gray scale voltage signal according to two different images to be displayed by the display system in two sequential frame periods; and an LCD device (410) comprising an LCD panel (40), a gate driving circuit (41), a source driving circuit (42), and a control circuit (47). The LCD panel includes a plurality of pixel units and liquid crystal molecules in the pixel units. The compensating source provides the compensative gray scale voltage signal to the source driving circuit via the control circuit, and the source driving circuit provides corresponding compensative gray scale voltages to the pixel units in order to drive the liquid crystal molecules in the pixel units to twist when the gate driving circuit scans the liquid crystal display panel.

### FIELD OF THE INVENTION

The present invention relates to display devices, and more particularly to a display system having a liquid crystal display (LCD) device with an external compensative unit.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 2 is an abbreviated circuit diagram of a conventional active matrix LCD. The active matrix LCD 100 includes an LCD panel 10, a gate driving circuit 11, a source driving circuit 12, and a control circuit 17. The LCD panel 10 includes a glass first substrate (not shown), a glass second substrate (not shown) facing the first substrate, and a liquid crystal layer (not shown) sandwiched between the first substrate and the second substrate.

The first substrate includes n rows of parallel scan lines 13, and k columns of parallel data lines 14 orthogonal to the n rows of parallel scan lines 13. The first substrate also includes a plurality of thin film transistors (TFTs) 15, which function as switching elements to drive corresponding pixel electrodes 151. Each of the TFTs 15 is positioned near a crossing of a corresponding scan line 13 and a corresponding data line 14. A gate electrode of the TFT 15 is electrically coupled to the scan line 13, and a source electrode of the TFT 15 is electrically coupled to the data line 14. Further, a drain electrode of the TFT 15 is electrically coupled to the corresponding pixel electrode 151.

The second substrate includes a plurality of common electrodes 152 opposite to the pixel electrodes 151. In particular, the common electrodes 152 are formed on a surface of the second substrate facing the first substrate, and are made from a transparent material such as ITO (Indium-Tin Oxide) or the like. A pixel electrode 151, a common electrode 152 facing the pixel electrode 151, and liquid crystal molecules of the liquid crystal layer sandwiched between the two electrodes 151, 152 cooperatively define a single pixel unit.

Generally, the LCD 100 includes a video signal terminal at a rear side thereof. In operation of the LCD 100, the video signal terminal is connected to a video source such as a personal computer. The personal computer provides video signal to the LCD 100 for displaying images. The gate driving circuit 11 outputs scanning signal to the plurality of scan lines 13, and the source driving circuit 12 outputs gray scale voltage to the plurality of data lines 14. The gray scale voltage correspond to data of images to be displayed on a screen of the LCD panel 10.

In operation, a common voltage is provided to all the common electrodes 152, and a gray scale voltage according to the data of the images to be displayed is provided to the pixel electrodes 151. Accordingly, in each pixel unit, an electrical field is generated between the two electrodes 151 and 152 so as to drive the liquid crystal molecules therebetween to twist a certain angle for displaying of images.

However, when the LCD 100 is used to display dynamic images, ‘image sticking’ may occur, particularly when two different images in two sequential frame periods are displayed. This phenomenon is due to the limited response speed of the liquid crystal molecules. That is, the liquid crystal molecules have a certain degree of inherent inertia, whereby they cannot timely twist to a desired angle according to each gray scale voltage applied during each successive frame period.

Referring to FIG. 3, this is an abbreviated circuit diagram of another conventional active matrix LCD, which has a compensative unit. The LCD 300 has a structure similar to that of the LCD 100. In particular, the LCD 300 includes an LCD panel 30, a gate driving circuit 31, a source driving circuit 32, a control circuit 37, and a compensative unit 38.

The compensative unit 38 includes a receiving terminal 381, a delay circuit 382, and a storage circuit 383. The storage circuit 383 includes two input ports and a transmitting terminal 384. The receiving terminal 381 connects to one of the input ports of the storage circuit 383, and the receiving terminal 381 also connects to the other input port of the storage circuit 383 via the delay circuit 382. The transmitting terminal 384 connects to the source driving circuit 32. The storage circuit 383 defines a look-up table therein, which is configured in advance. The look-up table includes a plurality of compensative gray scale voltage signal corresponding to images in two sequential frame periods.

In operation, the receiving terminal 381 receives data of an image in a first frame period, and transmits the data to the delay circuit 382. After that, the receiving terminal 381 receives data of the image in a second frame period, and transmits to the data to the storage circuit 383. At the same time, the delay circuit 382 transmits the data of the image in the first frame period to the storage circuit 383. The storage circuit 383 reads a compensative gray scale voltage signal from the look-up table according to the difference between the data of the image in the first frame period and the data of the image in the second frame period, and transmits the compensative gray scale voltage signal to the source driving circuit 32. The source driving circuit 32 generates corresponding gray scale voltage, which are provided to the data lines 34.

Due to the compensative gray scale voltage signal transmitted by the compensative unit 38, the gray scale voltage supplied to the data lines 34 are improved. That is, in each pixel unit during each frame period, the liquid crystal molecules can be driven to timely twist to the correct angle according to the gray scale voltage applied. Thus the problem of image sticking may be mitigated or even eliminated. However, the delay circuit 382 of the compensative unit 38 is typically a dynamic random access memory (DRAM), and the storage circuit 383 of the compensative unit 38 is typically an electrically erasable programmable read-only memory (EEPROM). The need for these memories makes the LCD 300 expensive.

It is desired to provide a display system an LCD device which can overcome the above-described deficiencies.

### SUMMARY

A display system includes an image compensating source disposed in a video source, the image compensating source is configured to generate a compensative gray scale voltage signal according to two different images to be displayed by the display system in two sequential frame periods; and a liquid crystal display device comprising a liquid crystal display panel, a gate driving circuit, a source driving circuit, and a control circuit. The liquid crystal display panel includes a plurality of pixel units and liquid crystal molecules in the pixel units. The compensating source provides the compensative gray scale voltage signal to the source driving circuit via the control circuit, and the source driving circuit provides corresponding compensative gray scale voltages to the pixel units in order to drive the liquid crystal molecules in the pixel units to twist when the gate driving circuit scans the liquid crystal display panel.

Other advantages and novel features will become more apparent from the following detailed description when taken in conjunction with the accompanying drawings. Any view in the drawings should be considered as schematic.

### BRIEF DESCRIPTION OF THE DRAWINGS

FIG. 1 is an abbreviated diagram of a display system according to an exemplary embodiment of the present invention.

FIG. 2 is an abbreviated circuit diagram of a conventional LCD.

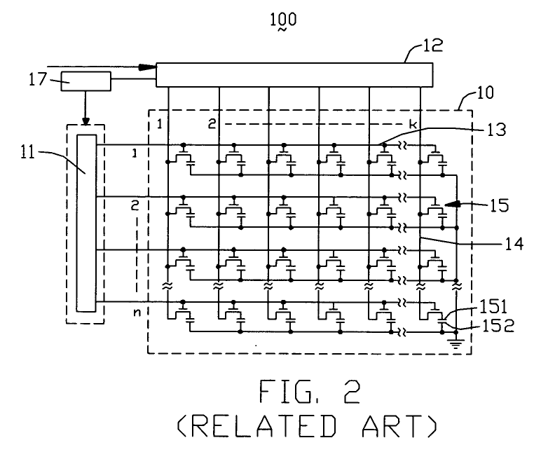

FIG. 3 is an abbreviated circuit diagram of another conventional LCD.

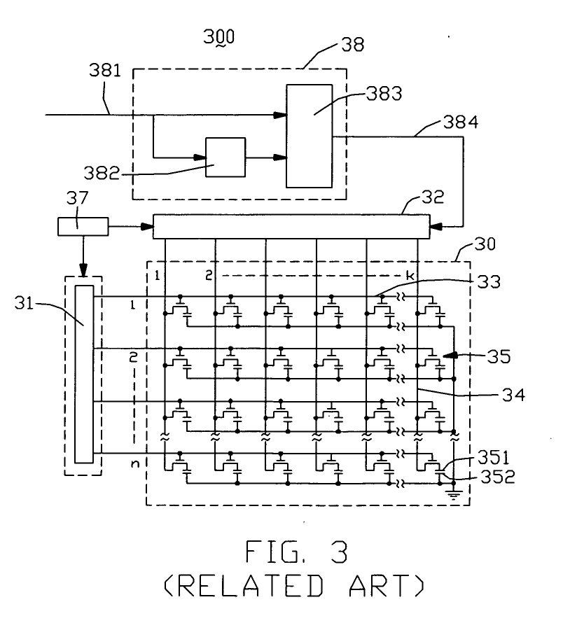

### DETAILED DESCRIPTION OF PREFERRED EMBODIMENTS

Reference will now be made to the drawings to describe preferred and exemplary embodiments of the present invention in detail.

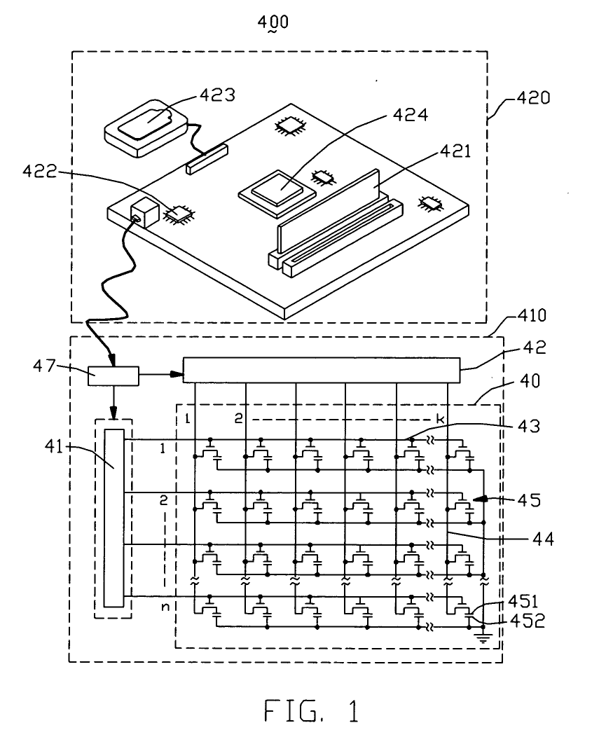

FIG. 1 is an abbreviated diagram of a display system according to an exemplary embodiment of the present invention. The display system 400 includes an LCD device 410 and a video source 420. The video source 420 is a personal computer (PC) in this embodiment.

The video source 420 includes a memory unit 421, a display control unit 422, a hard disk 423, and a central processing unit (CPU) 424. The display control unit 422 generates a plurality of video signal according to images in sequential frame periods. The hard disk 423 has a look-up table pre-stored therein. The look-up table includes a plurality of compensative gray scale voltage signal, corresponding to differences between two images in two sequential frame periods.

The LCD device 410 includes an LCD panel 40, a gate driving circuit 41, a source driving circuit 42, and a control circuit 47. In the exemplary embodiment, the LCD panel 40 is a twist nematic type LCD panel. The LCD panel 40 includes a glass first substrate (not shown), a glass second substrate (not shown) facing the first substrate, and a liquid crystal layer (not shown) sandwiched between the first substrate and the second substrate.

The first substrate includes n rows of parallel scan lines 43, and k columns of parallel data lines 44 orthogonal to the n rows of parallel scan lines 43. The first substrate also includes a plurality of thin film transistors (TFTs) 45, which function as switching elements to drive corresponding pixel electrodes 451. Each of the TFTs 45 is positioned near a crossing of a corresponding scan line 43 and a corresponding data line 44. A gate electrode of the TFT 45 is electrically coupled to the scan line 43, and a source electrode of the TFT 45 is electrically coupled to the data line 44. Further, a drain electrode of the TFT 45 is electrically coupled to the corresponding pixel electrode 451.

The second substrate includes a plurality of common electrodes 452 opposite to the pixel electrodes 451. In particular, the common electrodes 452 are formed on a surface of the second substrate facing the first substrate, and are made from a transparent material such as ITO (Indium-Tin Oxide) or the like. A pixel electrode 451, a common electrode 452 facing the pixel electrode 451, and liquid crystal molecules of the liquid crystal layer sandwiched between the two electrodes 451, 452 cooperatively define a single pixel unit.

The LCD device 410 includes a video signal terminal (not shown) at a rear side thereof, which is connected to a terminal (not labeled) of the video source 420. The video signal terminal of the LCD device 410 is electrically connected to the control circuit 47.

In operation, the memory unit 421 of the video source 420 stores data of an image in a first frame period. After that, the CPU 424 reads data of a next image in the second frame period and the data of the image in the first frame period at the same time, so as to read out a compensative gray scale voltage signal from the look-up table of the hard disk 423 according to a difference between the data of the image in the first frame period and the data of the image in the second frame period. Finally, the compensative gray scale voltage signal is transmitted to the control circuit 47 via the terminal of the video source 420 and the video signal terminal of the LCD device 410.

The video source 420 provides video signal to the LCD device 410 in the manner described above. In the LCD device 410, the source driving circuit 32 receives the compensative gray scale voltage signal, and generates corresponding compensative gray scale voltage. A common voltage is provided to all the common electrodes 452. In general, under control of the control circuit 37, gray scale voltage according to data of images to be displayed are provided to the pixel electrodes 451 via the data lines 44 by the source driving circuit 32 when the gate driving circuit 41 outputs scanning signal to the scan lines 43 to turn on the corresponding TFTs 45. Thus, the compensative gray scale voltage are provided to the corresponding pixel electrodes 451 via the data lines 44. Accordingly, in each pixel unit during each frame period, an electrical field is generated between the two electrodes 451 and 452 so as to drive the liquid crystal molecules to timely twist to a correct angle for displaying of a corresponding image on a screen of the LCD panel 40.

In summary, the compensative gray scale voltage signal transmitted by the video source 420 to the LCD device 410 enables the resulting gray scale voltage to be improved. That is, the compensative gray scale voltage enable the liquid crystal molecules in each pixel unit to be driven to twist to a correct angle during each frame period. Thus any image the sticking that may otherwise occur is mitigated or even eliminated. Moreover, the compensative gray scale voltage signal is supplied to the LCD device 410 by an external compensative unit, namely the video source 420. Unlike in conventional art, there is no need for the LCD device 410 to be equipped with an expensive delay circuit (e.g., a DRAM) or an expensive storage circuit (e.g., an EEPROM). Instead, the display system 400 can simply make use of hardware that normally already exists in a commonplace video source 420 such as a PC. Because there is no need to equip the LCD device 410 with expensive components, the cost of the LCD device 410 can be reduced.

Various modifications and alterations are possible within the ambit of the invention herein. For example, the look-up table of the hard disk 423 of the video source 420 may be substituted by an equation or algorithm. The equation or algorithm expresses a function according to compensative gray scale voltage signal corresponding to images in two sequential frame periods. The video source 420 may output a compensative gray scale voltage signal to the control circuit 47 of the LCD device 410 by calculating according to the equation or algorithm. In another example, the LCD device 400 may instead be an in-plane switching (IPS) thin film transistor (TFT) LCD device, in which the common electrodes and the pixel electrodes are disposed at a same substrate of the LCD device. In a further example, the video source may instead be a mobile phone, an in-vehicle video player, or the like.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A display system, comprising:
an image compensating source disposed in a video source, the image compensating source being configured to generate a compensative gray scale voltage signal according to two different images to be displayed by the display system in two sequential frame periods; and
a liquid crystal display device comprising a liquid crystal display panel, a gate driving circuit, a source driving circuit, and a control circuit, the -liquid crystal display panel comprising a plurality of pixel units and liquid crystal molecules in the pixel units;
wherein the compensating source provides the compensative gray scale voltage signal to the source driving circuit via the control circuit, and the source driving circuit provides corresponding compensative gray scale voltage to the pixel units in order to drive the liquid crystal molecules in the pixel units to twist when the gate driving circuit scans the liquid crystal display panel.

2. The display system as claimed in claim 1, wherein the liquid crystal display device includes a first substrate, a second substrate facing the first substrate, and a liquid crystal layer sandwiched between the first substrate and the second substrate, and the liquid crystal layer comprises the liquid crystal molecules.

3. The display system as claimed in claim 2, wherein the liquid crystal display device is a twist nematic type liquid crystal display device.

4. The display system as claimed in claim 2, wherein the liquid crystal display device is an in-plane switching liquid crystal display device.

5. The display system as claimed in claim 1, wherein the video source is a personal computer.

6. The display system as claimed in claim 5, wherein the personal computer comprises a display control unit for generating gray scale voltage signal according to images in sequential frame periods.

7. The display system as claimed in claim 6, wherein the personal computer further comprises a memory unit and a hard disk, the hard disk pre-stores a look-up table having a plurality of compensative gray scale voltage signal therein; the memory unit stores the data of the image in a first frame period therein, after that, the personal computer read out the data of the next image in the second frame period and the data of the image in the first frame period at the same time, then so as to read out a compensative gray scale voltage signal from the look-up table of the hard disk according to the difference between the data of the images in the first frame period and the second frame period.

8. The display system as claimed in claim 6, wherein the personal computer further comprises a hard disk, the hard disk pre-stores an equation therein, which is the function according to the compensative gray scale voltage signal corresponding to the images in two sequential frame periods; the personal compute generates a compensative gray scale signal by calculating the equation according to images in two sequential frame periods.

9. The display system as claimed in claim 1, wherein the video source is a mobile phone.

10. The display system as claimed in claim 1, wherein the video source is an in-vehicle display player.

11. The display system as claimed in claim 1, wherein the liquid crystal display panel comprises a first substrate and a second substrate, the first substrate comprises a plurality of rows of parallel scan lines, a plurality of columns of parallel data lines orthogonal to the scan lines, a plurality of pixel electrodes, and a plurality of thin film transistors, each of the thin film transistors is positioned near a crossing of a corresponding scan line and a corresponding data line, a gate electrode of the thin film transistors is electrically coupled to the scan line, and a source electrode of the thin film transistors is electrically coupled to the data line, a drain electrode of the thin film transistors is electrically coupled to the corresponding pixel electrode.

12. The display system as claimed in claim 11, wherein the second substrate comprises a plurality of common electrodes opposite to the pixel electrodes.

13. The display system as claimed in claim 11, wherein the second substrate further comprises a plurality of common electrodes opposite to the pixel electrodes.

14. The display system as claimed in claim 12, wherein the common electrodes are made of Indium-Tin Oxide.

15. A method of making a display system, comprising steps of:
providing an image compensating source disposed in a video source, the image compensating source being configured to generate a compensative gray scale voltage signal according to two different images to be displayed by the display system in two sequential frame periods; and
providing a liquid crystal display device comprising a liquid crystal display panel, a gate driving circuit, a source driving circuit, and a control circuit, the liquid crystal display panel comprising a plurality of pixel units and liquid crystal molecules in the pixel units;
wherein the compensating source provides the compensative gray scale voltage signal to the source driving circuit via the control circuit, and the source driving circuit provides corresponding compensative gray scale voltage to the pixel units in order to drive the liquid crystal molecules in the pixel units to twist when the gate driving circuit scans the liquid crystal display panel.
